(19) United States
(12) Patent Application Publication
(10) Pub. No.: US 2005/0259666 A1
(43) Pub. Date: Nov. 24, 2005

(54) Method for distributing and collecting address information

(75) Inventor: Tomoki Okawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/088,850

(22) Filed: Mar. 25, 2005

(30) Foreign Application Priority Data
Mar. 25, 2004 (JP) P2004-090580

(51) Int. Cl. H04L 12/28

(52) U.S. Cl. 370/397

(57) ABSTRACT

A method for distributing and collecting an address information includes: transmitting an address information acquisition command from an originating terminal to a reception terminal, the address information acquisition command attached with an address information containing a group identifier of the originating terminal; registering the address information transmitted from the originating terminal in an address book provided in the reception terminal; searching the address book provided in the reception terminal for address information containing a group identifier that is same as the group identifier contained in the address information transmitted from the originating terminal; transmitting the address information found in the searching from the reception terminal to the originating terminal; and registering the address information transmitted from the reception terminal in an address book provided in the originating terminal.

The present disclosure relates to the subject matter contained in Japanese Patent Application No. 2004-090580 filed on Mar. 25, 2004, which is incorporated herein by reference in its entirety.

### BACKGROUND OF THE INVENTION

1. Field of the Invention

The present invention relates to a system for enabling destination information of telephone numbers, etc., to be automatically exchanged between terminals having the same group identifier and automatically collecting destination information of the telephone numbers, etc., of parties having the same group identifier with communications between the terminals.

2. Description of the Related Art

A related art of copying destination information in a conventional terminal into a new model of terminal used for model change, etc., in a mobile telephone shop, etc., is known as an example of acquiring a telephone directory (destination information) in a mobile telephone (terminal).

As a related art of exchanging address information through an exchange (server), the following is known. (Refer to JP-A-2000-134310.)

The art described in JP-A-2000-134310 is an embodiment wherein from a terminal 68 having already registered telephone number information, the telephone number information is transferred to another terminal 70 for updating the information in the terminal 70, as shown in FIG. 8. In the figure, the terminal 68 sends information to a base station 72 and the information is sent to the terminal 70 through an exchange 74 and a base station 76.

The operation in FIG. 8 will be discussed with a flowchart of FIG. 9.

As a method of an information request between terminals, a method of transmitting and receiving a request and telephone number information by the time a call setting message or line connection is complete or a method of placing data in a communicatable state and then transmitting and receiving data is available. In the embodiment, an example of placing data in a communicatable state and then transmitting and receiving data is shown.

At the terminal 68, power is turned on at step 30 and a calling signal is transmitted to the exchange 74 at step 31.

In the exchange 74, the calling signal is received at step 32, the received signal is analyzed at step S33, telephone number translation is conducted at step S34, and a ringing signal is transmitted to the terminal 70 at step S35.

At the terminal 70, power is already on, the ringing signal is received at step S36, and an answer signal is transmitted to the exchange 74 at step 37.

Upon reception of the answer signal at step 38, the exchange 74 transmits a call acceptance signal to the terminal 68 at step 39, whereby line connection is made at step 40. That is, a communicatable state is entered.

This sequence is similar to conventional call connection processing.

Next, upon reception of the call acceptance signal at step 41, the terminal 68 collects registered telephone number information data at step 42 and transmits the registered telephone number information data to the exchange 74 at step 43. The exchange 74 receives the registered telephone number information data at step 44 and transmits the registered telephone number information data to the terminal 70 at step 45.

The terminal 70 receives the registered telephone number information data at step 46 and updates telephone number information in a telephone number list update control section 76 at step 47 and sends an update termination signal to the exchange 74 at step 48. Upon reception of the update termination signal at step 49, the exchange 74 transmits a transfer termination signal to the terminal 68 at step 50.

Upon reception of the transfer termination signal at step 51, the terminal 68 performs call disconnection processing and turns off the power.

At the terminal 70, after step 48, call disconnection processing is performed and the power is turned off.

As a related art using the Internet, the following is known: (Refer to JP-A-2003-244308.)

There is disclosed in JP-A-2003-244308 a following art:

“A system for enabling the user to register, correct, and delete an address book registering personal information, for example, an address book in a mobile telephone from HTTP, JAVA (registered trademark), or a dedicated application operating in a mobile telephone, a personal computer, a PDA terminal, etc., having a function connectable to the Internet, the system that can be used with a mobile telephone, a personal computer, a PDA terminal, etc., having a function connectable to the Internet.”

If a person having a mobile telephone changes personal information using the system, an address book database is searched based on the ID of the person having the mobile telephone, and the owners of mobile telephones registered in the address book of the person having the mobile telephone and registering information on the person having the mobile telephone 20 are listed.

At this time, the person having the mobile telephone can determine whether or not to update the address book of a different mobile telephone owner for updating the address book.

For example, when the telephone number of the person having the mobile telephone changes, if change of information registered in the address book of a different mobile telephone owner is permitted, the different mobile telephone owner can call the person having the mobile telephone if the different mobile telephone owner does not know the fact that the telephone number of the person having the mobile telephone changes.

### SUMMARY OF THE INVENTION

However, in the first method described above, there is a problem that the address information in the already existing terminal is copied into a new model of terminal and all address information (data) is copied and therefore unnecessary data or data that should not be copied is also copied.

In order to copy address information, the terminals need to exist in the same location and therefore it is difficult to share the address information among the terminals owned by a plurality of persons at distant locations.

In the second method, there are problems that the address information is copied from one terminal to another through the exchange (communication network) (duplicate data is updated) and the address information can also be exchanged between the terminals at distant locations, but the exchange (server) is required and unnecessary data or data that should not be copied is also copied.

Further, in the third method, there is a problem that the address book in the server constructed on the Internet is shared, whereby the data to be shared with other specific persons (destination information) can be provided for the members belonging to a specific group, but centralized management of the server becomes necessary, leading to the cost of installing, maintaining, and administrating the server (containing the security measures).

Since the personal information is registered in the address book in the server constructed on the Internet, the user may hold an uncertain, insecure feeling such that a stranger may know the registered personal information.

It is therefore an object of the invention to provide a system for enabling address information of telephone numbers, etc., to be automatically exchanged between terminals having the same group identifier and automatically distributing and collecting address information of the telephone numbers, etc., of parties having the same group identifier with communications between the terminals.

According to a first aspect of the invention, there is provided a method for distributing and collecting an address information, the method including: transmitting an address information acquisition command from an originating terminal to a reception terminal, the address information acquisition command attached with an address information containing a group identifier of the originating terminal; registering the address information transmitted from the originating terminal in an address book provided in the reception terminal; searching the address book provided in the reception terminal for address information containing a group identifier that is same as the group identifier contained in the address information transmitted from the originating terminal; transmitting the address information found in the searching from the reception terminal to the originating terminal; and registering the address information transmitted from the reception terminal in an address book provided in the originating terminal.

According to a second aspect of the invention, there is provided a computer-readable program product for causing a computer installed in a transmission-reception terminal to execute: transmitting an address information acquisition command from an originating terminal to a reception terminal, when the transmission-reception terminal operates as the originating terminal, the address information acquisition command attached with an address information containing a group identifier of the originating terminal; registering the address information transmitted from the originating terminal in an address book provided in the reception terminal, when the transmission-reception terminal operates as the reception terminal; searching the address book provided in the reception terminal for address information containing a group identifier that is same as the group identifier contained in the address information transmitted from the originating terminal, when the transmission-reception terminal operates as the reception terminal; transmitting the address information found in the searching from the reception terminal to the originating terminal, when the transmission-reception terminal operates as the reception terminal; and registering the address information transmitted from the reception terminal in an address book provided in the originating terminal, when the transmission-reception terminal operates as the originating terminal.

According to a third aspect of the invention, there is provided a transmission-reception terminal including: means for transmitting an address information acquisition command from an originating terminal to a reception terminal, when the transmission-reception terminal operates as the originating terminal, the address information acquisition command attached with an address information containing a group identifier of the originating terminal; means for registering the address information transmitted from the originating terminal in an address book provided in the reception terminal, when the transmission-reception terminal operates as the reception terminal; means for searching the address book provided in the reception terminal for address information containing a group identifier that is same as the group identifier contained in the address information transmitted from the originating terminal, when the transmission-reception terminal operates as the reception terminal; means for transmitting the address information found in the searching from the reception terminal to the originating terminal, when the transmission-reception terminal operates as the reception terminal; and means for registering the address information transmitted from the reception terminal in an address book provided in the originating terminal, when the transmission-reception terminal operates as the originating terminal.

### BRIEF DESCRIPTION OF THE DRAWINGS

In the accompanying drawings:

FIG. 1 is a drawing to show an example of address books of terminals to which an embodiment of the invention is applied;

FIG. 2 is a first drawing to describe change in the contents of the address books for conducting communications between the terminals to which the embodiment of the invention is applied;

FIG. 3 is a second drawing to describe change in the contents of the address books for conducting communications between the terminals to which the embodiment of the invention is applied;

FIG. 4 is a third drawing to describe change in the contents of the address books for conducting communications between the terminals to which the embodiment of the invention is applied;

FIG. 5 is a drawing to describe the capability of distributing address information to a terminal not directly communicating in the terminals to which the embodiment of the invention is applied;

FIG. 6 is a drawing to show the data contents of address books of terminals to which another embodiment of the invention is applied;

FIG. 7 is a drawing to describe transmission of address information when P to P mail is exchanged between the terminals to which the embodiment of the invention is applied;

FIG. 8 is a drawing to show an example of transferring telephone number information from a terminal having already registered telephone number information to another terminal in a related art; and

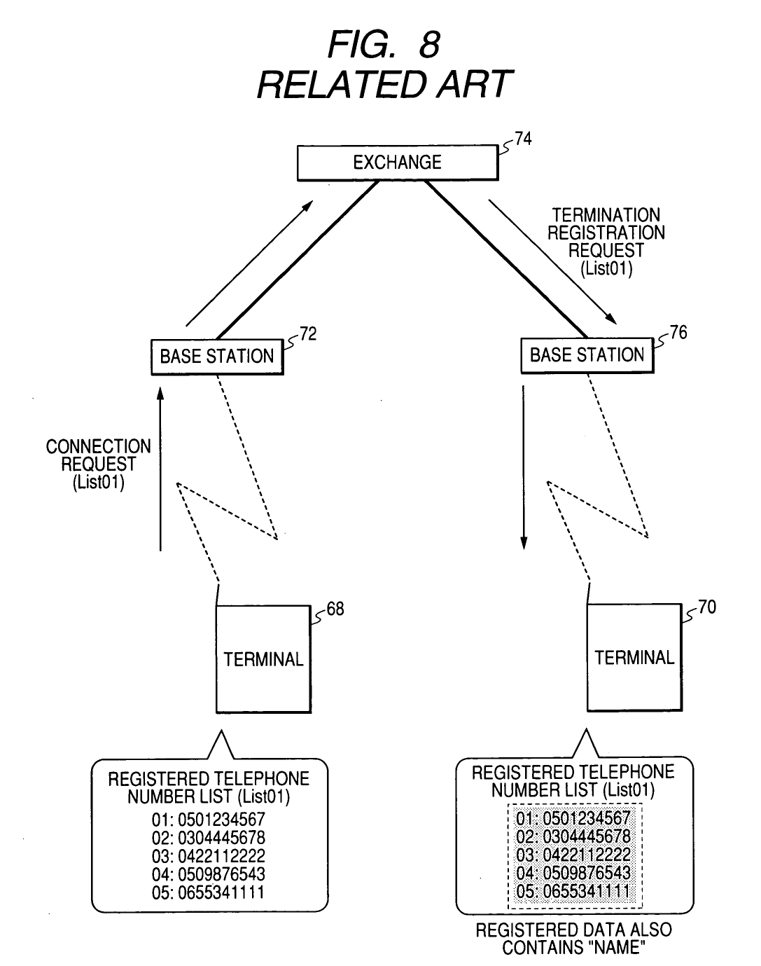

FIG. 9 is a flowchart to describe the operation in the related art in FIG. 8.

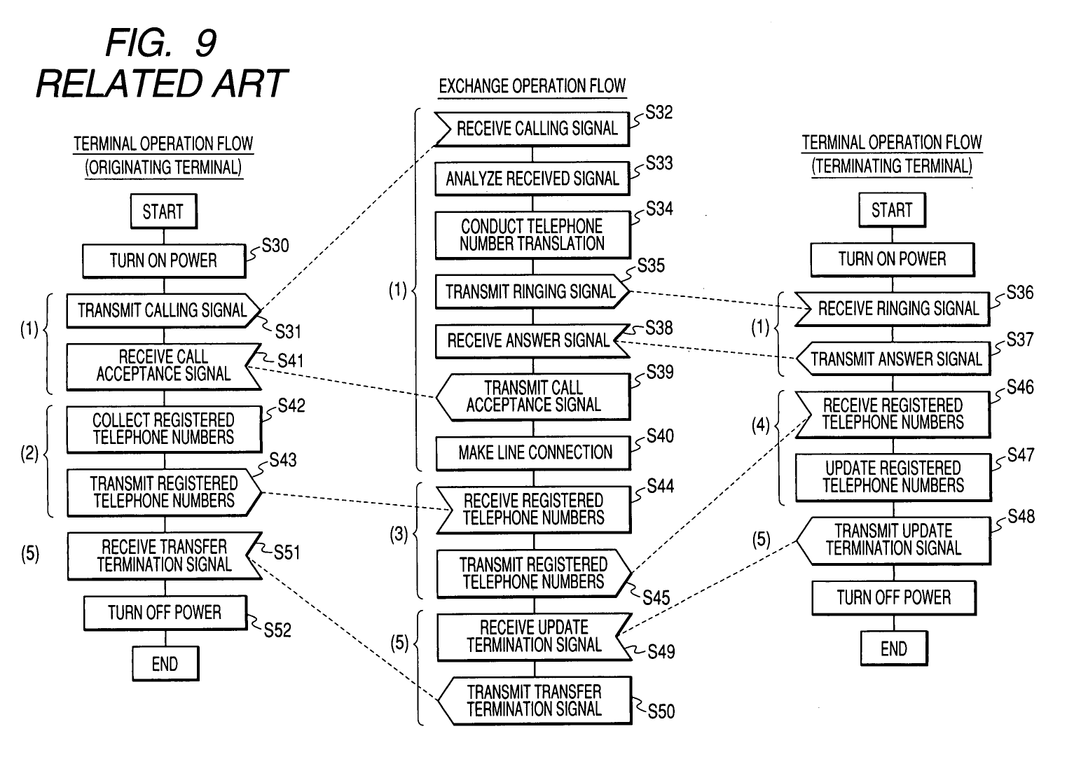

### DETAILED DESCRIPTION OF THE PREFERRED EMBODIMENTS

Referring now to the accompanying drawings, there are shown a preferred embodiment of the invention.

In order to describe an outline of the embodiment of the invention, it is assumed that communication units and a storage area for storing address information (address book) are installed in each of two terminals of A and E communicating with each other.

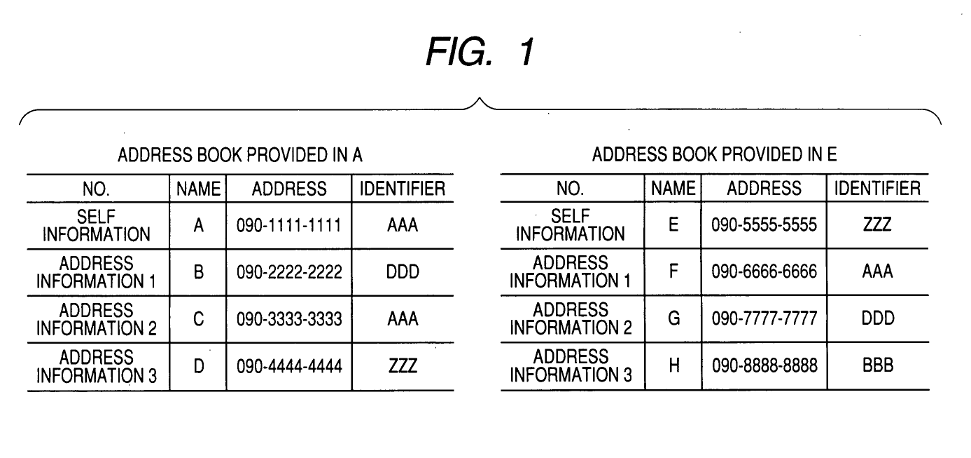

FIG. 1 shows an example of the address books of A and E.

The address information in the invention is as follows:
Main key information (main key): Name, etc.
Destination information (address): Mobile telephone number, E-mail address, IP address, etc.
Group identifier for sharing address information (simply, identifier): Identifier used to automatically share address information (which may be secret password)

Each address book in FIG. 1 retains self information (the information concerning the terminal itself) and other addresses (B, C, and D in the address book provided in A; F, G, and H in the address book provided in E).

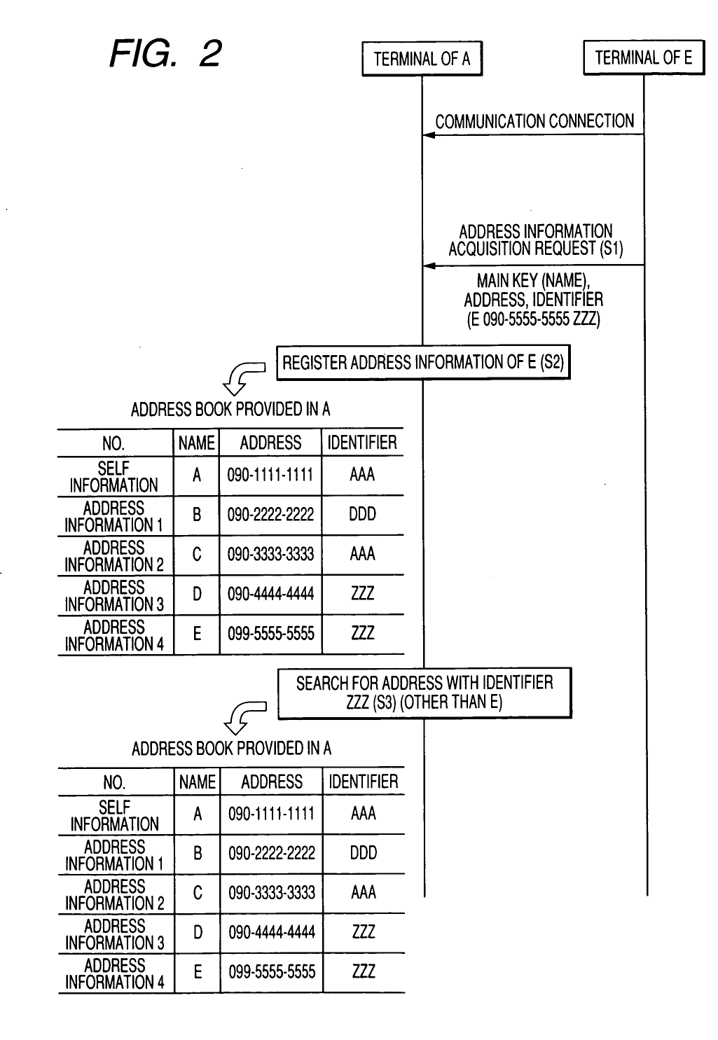

Change in the contents of the address books for conducting communications between the terminals (P to P) installing the address books in FIG. 1 will be discussed with FIG. 2.

To begin with, the terminal of E sends a communication connection request to the terminal of A (S1).

In communication connection (or after communication connection), the originating terminal E transmits a communication command of an address information acquisition request (address information request command).

The address information acquisition request contains the main key (name), the address, and the identifier of the originating terminal E.

Upon reception of the address information acquisition request, the reception terminal A registers the main key (name) , the address, and the identifier of the originating terminal E contained in the command in the address book provided in the reception terminal A (S2).

After registering them, the reception terminal A searches its address book for the address having the same identifier as the originating terminal E (ZZZ) other than the address of the originating terminal E (S3).

As the result of the search, the address having the same identifier as the originating terminal E (ZZZ) is found.

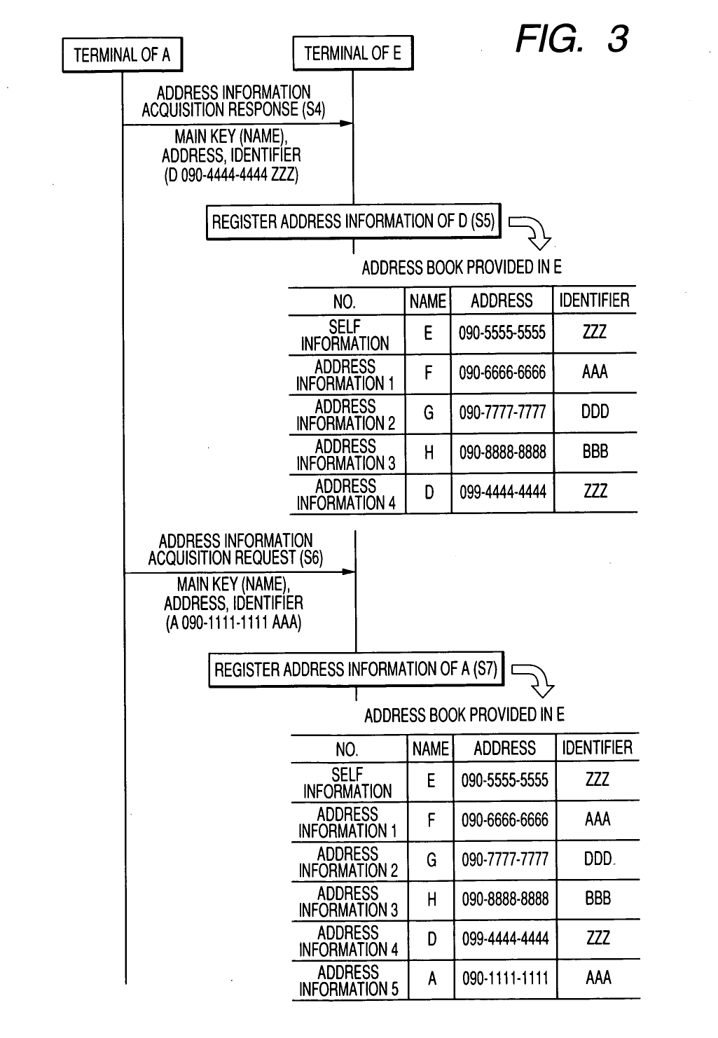

The case where the address information having the same identifier as the originating terminal E (ZZZ) is found as the result of the search will be discussed with FIG. 3.

The reception terminal A transmits the address information D to the originating terminal E as an address information acquisition response (S4).

The transmitted address information contains the main key (name), the address, and the identifier.

Upon reception of the address information acquisition response, the originating terminal E registers the main key (name), the address, and the identifier of the originating terminal D contained in the response in the address book provided in the originating terminal E (S5).

The terminal A transmits an address information acquisition request to the terminal E according to a similar procedure (S6), whereby the address information of the terminal A is registered in the address book provided in the terminal E (S7).

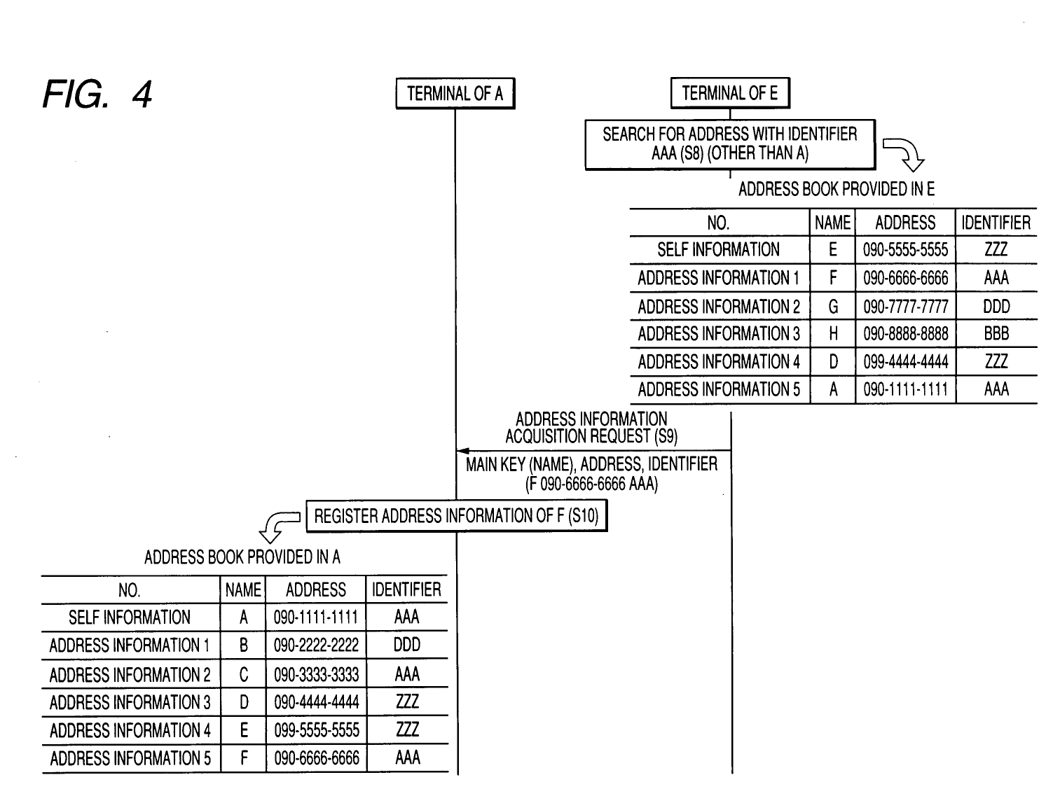

The subsequent procedure will be discussed with FIG. 4.

The terminal E searches its address book for the address having the same identifier as the terminal A other than the address of the terminal A (S8) and if the corresponding address is found, the terminal E transmits the found address to the terminal A as an address information acquisition response (S9).

The terminal A registers the address information F of the received address information acquisition response in the address book provided in the terminal A (S10).

In the procedure, the terminal A can automatically acquire the address information of the connection terminal E and the terminal F having the identifier to which the terminal A belongs. The terminal E can automatically acquire the address information of the connection terminal A and the terminal D having the identifier to which the terminal E belongs.

In the address information acquisition method, the address information of the party with which the terminal does not directly communicate (in the example, the terminal A can acquire the address information of the terminal F and the terminal E can acquire the address information of the terminal D).

At the same time, each of the terminals A and E can also cause its address information to be registered in the address book of the communicating party for automatically disseminating the address information.

Further, it is also made possible to share address information with a terminal not directly connected in communications (terminal with unknown destination address) if the terminal has the same identifier.

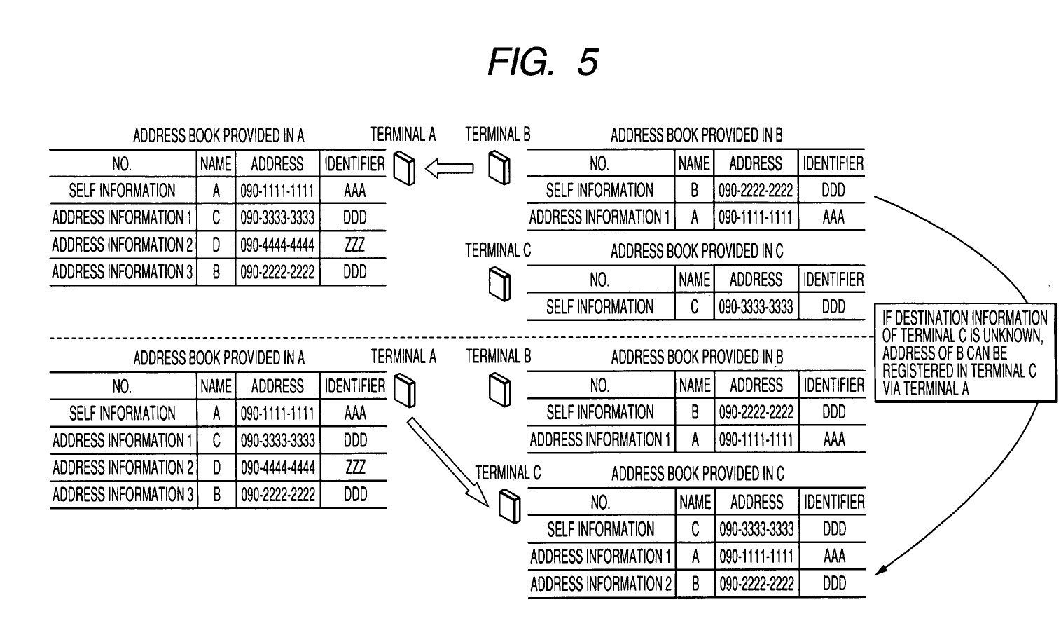

The state is schematically shown in FIG. 5.

In the state at the upper stage of FIG. 5, terminals B and C have a common identifier (DDD), but do not communicate with each other and therefore the address information of one terminal is not registered in the address book of the other.

In this state, if the terminal B makes communication connection to the terminal A, the address information of the terminal B is registered in the address book provided in the terminal A.

In this state, the terminal A makes communication connection to the terminal C and the address information of the terminal A is registered in the address book provided in the terminal C, as at the lower stage of FIG. 5.

Then, when the terminal C transmits an address information acquisition request (command) to the terminal A, the address book provided in the terminal A is searched for the address information having the same identifier as the identifier of the terminal C (DDD), and the address information of the terminal B of the search result is transmitted to the terminal C and is registered in the address book provided in the terminal C.

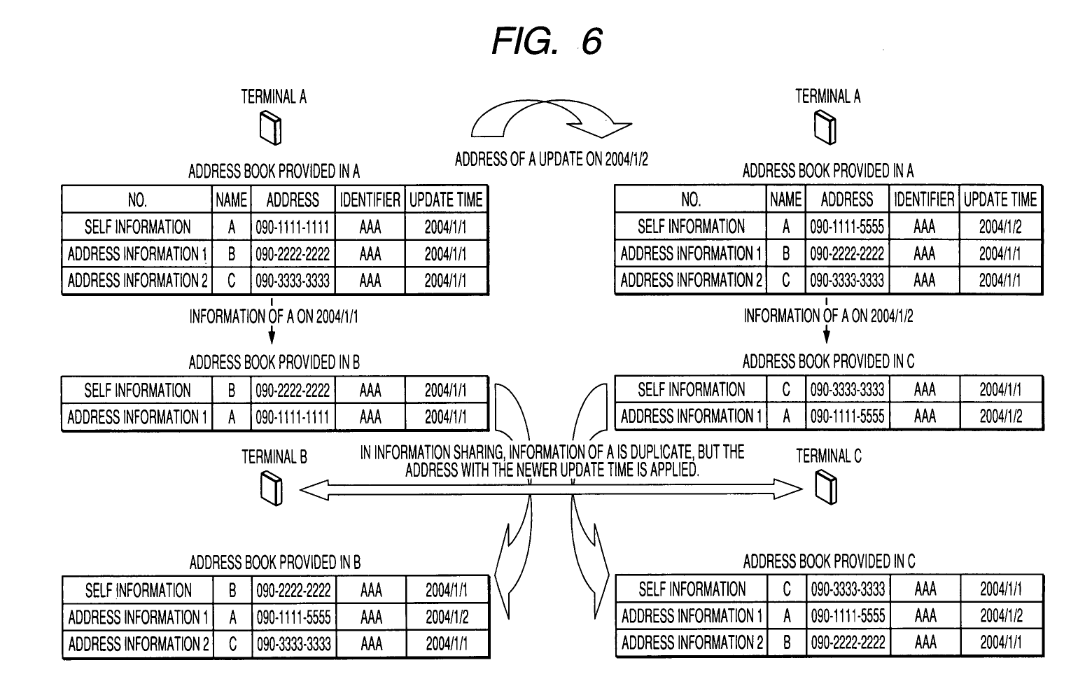

Next, another embodiment of the invention will be discussed with FIG. 6.

In the example in FIG. 6, address information registered in an address book is provided with update time information of the address, whereby the address information with the newer update time takes precedence over the duplicate address information with the older update time.

The upper stage of FIG. 6 shows a state in which the address book provided in a terminal A is updated from 2004 Jan. 1 to 2004 Jan. 2.

The address in the address information of the terminal A in the upper left portion of FIG. 6 is updated from “090-1111-1111” to “090-1111-5555” in the upper right portion on 2004 Jan. 2.

In this state, when the terminal A makes communication connection to a terminal C, the address information of the terminal A (updated on 2004 Jan. 2) is registered in the address book provided in the terminal C as shown in the intermediate right portion.

At this point in time, however, the address information of the terminal A registered in the address book provided in a terminal B is address information before being updated as shown in the intermediate left portion.

Then, when the terminals B and C make communication connection to each other, the address information of the terminal B is registered in the address book provided in the terminal C and the address information of the terminal A transmitted from the terminal C in response to an address information acquisition request from the terminal B is registered in the terminal B as shown in the lower right portion, in which case the update time information is referenced and the information with the newer update time takes precedence and is registered as shown in the lower left portion.

In FIG. 6, a date is shown as the update time, but it is desirable that information in more detailed time units should be retained.

In the description given above, when communication connection is made, automatically the address information is shared (registered, acquired), but some users do not want to share the address. Thus, a function of allowing the user to reject sharing the address information if information with the match identifier is found in response to an address information acquisition request can also be added.

In the description given above, the data of the name, the address, the identifier, and the update time is shown as the address information, but any other data (for example, personal information such as the postal address or the date of birth or any other information) can also be added to the address information.

The address information (particularly, the identifier) is encrypted, whereby security can also be enhanced.

As described above, as the terminals, the invention can be applied not only to telephones such as a mobile telephone (a fixed telephone is also possible), an IP telephone, and a FAX, but also to communication terminals for making P to P connection using an IP address (for example, video conference, voice conference, data conference, chat) as well as P to P mail.

In the description with FIGS. 1 to 6, the case of the terminals with the addresses as the telephone numbers is taken as an example, but the principles of the invention can also be applied to P to P mail, etc.

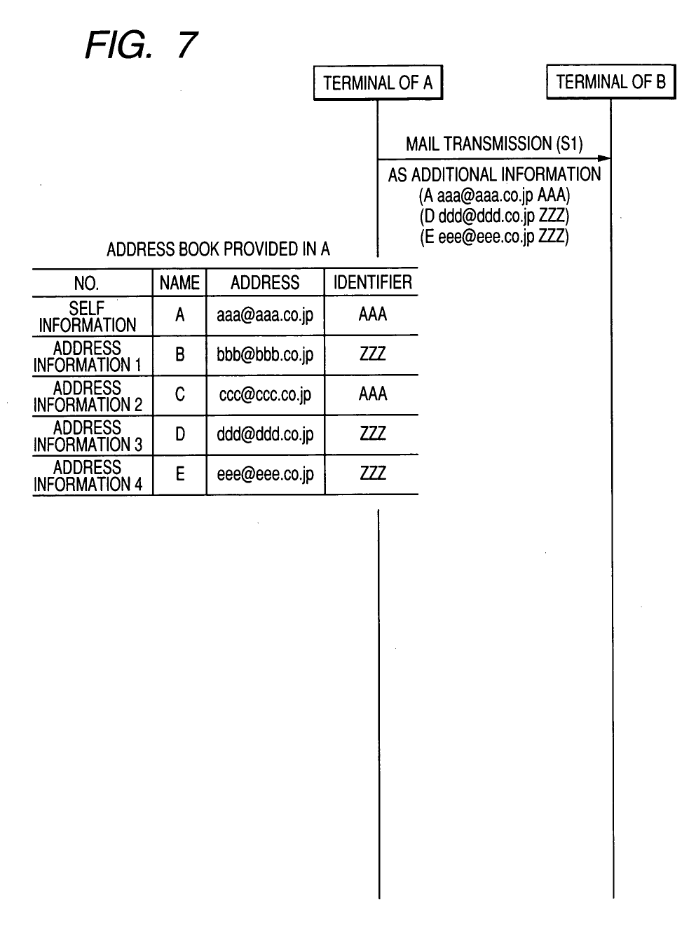

An example will be discussed with FIG. 7.

As shown in FIG. 7, in communication connection from the terminal of A to the terminal of B, when the terminal of A sends mail to the terminal of B, the address information having the identifier of the terminal B (ZZZ) in the address book provided in the terminal of A is transmitted as additional information (The address information of A is also sent together.) (S1).

Upon reception of the address information as the additional information, the terminal of B automatically registers the address information in the address book provided in the terminal of B.

The address update time as in FIG. 6 can also be contained in the address information.

Although the present invention has been shown and described with reference to the preferred embodiment, various changes and modifications will be apparent to those skilled in the art from the teachings herein. Such changes and modifications as are obvious are deemed to come within the spirit, scope and contemplation of the invention as defined in the appended claims.

1 . A method for distributing and collecting an address information, the method comprising:
transmitting an address information acquisition command from an originating terminal to a reception terminal, the address information acquisition command attached with an address information containing a group identifier of the originating terminal;
registering the address information transmitted from the originating terminal in an address book provided in the reception terminal;
searching the address book provided in the reception terminal for address information containing a group identifier that is same as the group identifier contained in the address information transmitted from the originating terminal;
transmitting the address information found in the searching from the reception terminal to the originating terminal; and
registering the address information transmitted from the reception terminal in an address book provided in the originating terminal.

2. The method as claimed in claim 1, wherein the address information further contains at least one of a name, a telephone number, and an E-mail address.

3. The method as claimed in claim 1, wherein the address information further contains update time information that indicates time when the address information is updated, and
wherein, in registering the address information in the address book provided in the originating terminal, the address information containing the update time indicating newer time is preferentially registered when the address information transmitted from the reception terminal is duplicate in the address book provided in the originating terminal.

4. The method as claimed in claim 1, further comprising allowing a user of the reception terminal to reject the transmitting of the address information found in the searching.

5. The method as claimed in claim 1, wherein the address information acquisition command is contained in a communication request transmitted from the originating terminal to the reception terminal.

6. A computer-readable program product for causing a computer installed in a transmission-reception terminal to execute:
transmitting an address information acquisition command from an originating terminal to a reception terminal, when the transmission-reception terminal operates as the originating terminal, the address information acquisition command attached with an address information containing a group identifier of the originating terminal;
registering the address information transmitted from the originating terminal in an address book provided in the reception terminal, when the transmission-reception terminal operates as the reception terminal;
searching the address book provided in the reception terminal for address information containing a group identifier that is same as the group identifier contained in the address information transmitted from the originating terminal, when the transmission-reception terminal operates as the reception terminal;
transmitting the address information found in the searching from the reception terminal to the originating terminal, when the transmission-reception terminal operates as the reception terminal; and
registering the address information transmitted from the reception terminal in an address book provided in the originating terminal, when the transmission-reception terminal operates as the originating terminal.

7. A transmission-reception terminal comprising:
means for transmitting an address information acquisition command from an originating terminal to a reception terminal, when the transmission-reception terminal operates as the originating terminal, the address information acquisition command attached with an address information containing a group identifier of the originating terminal;
means for registering the address information transmitted from the originating terminal in an address book provided in the reception terminal, when the transmission-reception terminal operates as the reception terminal;
means for searching the address book provided in the reception terminal for address information containing a group identifier that is same as the group identifier contained in the address information transmitted from the originating terminal, when the transmission-reception terminal operates as the reception terminal;
means for transmitting the address information found in the searching from the reception terminal to the originating terminal, when the transmission-reception terminal operates as the reception terminal; and
means for registering the address information transmitted from the reception terminal in an address book provided in the originating terminal, when the transmission-reception terminal operates as the originating terminal.
